(19) United States
(12) Patent Application Publication
(10) Pub. No.: US 2026/0237980 A1
(43) Pub. Date: Aug. 13, 2026

(54) GENERATOR DISTRIBUTION BOX

(71) Applicant: YAMABIKO CORPORATION, Tokyo (JP)

(72) Inventor: Keisuke HOSHINO, Tokyo (JP)

(21) Appl. No.: 19/445,976

(22) Filed: Jan. 12, 2026

(30) Foreign Application Priority Data
Feb. 7, 2025 (JP) 2025-019291

(51) Int. Cl. H02B 1/48; H02B 1/04; H02B 1/20; H02B 1/50; H02B 1/52

(52) U.S. Cl. CPC H02B 1/48; H02B 1/041; H02B 1/202; H02B 1/50; H02B 1/52

(57) ABSTRACT

A generator distribution box configured to increase connection ports for power supply destinations includes: a box body including an open side; a lid configured to open or close the open side; and an outlet panel accommodated in the box body and including a plurality of outlet sockets exposed through the open side. Connection terminals of the outlet panel are exposed through an opening formed in a bottom portion of the box body. The lid accommodates a connection cable to connect the connection terminals to output terminals of a generator, and a hooking member adapted to be attachable to an outer surface of the box body so that the box body is hooked on a part of the generator or a peripheral facility of the generator by means of the hooking member. A portable handle is provided on at least one of the box body and the lid.

### CROSS-REFERENCE TO RELATED APPLICATIONS

The present application claims priority from Japanese Patent Application No. 2025-019291 filed on February 7, 2025, and the entire contents of which are hereby incorporated by reference.

### BACKGROUND

### 1. Technical field

The present invention relates to a generator distribution box.

### 2. Related Art

An example of conventional generators is disclosed in Japanese Patent Application Laid-Open No. 2012-105472, in which a power generation unit and a prime mover such as an engine for driving the power generation unit are accommodated in a box-shaped casing, and an operation panel for controlling the prime mover and the power generation unit, as well as an output terminal board for outputting power generated by the power generation unit to the outside, are arranged on one side of the casing.

The output terminal board provided in a conventional generator is equipped with both plug-in outlets and cable-connection type output terminals, in consideration of the manner of connection to a load. A power supply cord plug is connected to the outlet sockets, while the other end of a cable, one end of which is connected to a terminal of a power supply destination, is connected to the output terminals. The entire contents of Japanese Patent Application Laid-Open No. 2012-105472 are hereby incorporated by reference.

### SUMMARY

An aspect of the present invention has the following features.

A generator distribution box configured to increase connection ports for power supply destinations includes: a box body including an open side; a lid configured to open or close the open side; and an outlet panel accommodated in the box body and including a plurality of outlet sockets exposed through the open side. Connection terminals of the outlet panel are exposed through an opening formed in a bottom portion of the box body. The lid accommodates a connection cable to connect the connection terminals to output terminals of a generator, and a hooking member adapted to be attachable to an outer surface of the box body so that the box body is hooked on a part of the generator or a peripheral facility of the generator by means of the hooking member. A portable handle is provided on at least one of the box body and the lid.

The generator distribution box includes: a box body including an open side; a lid mounted to the box body so as to allow the open side to be opened or closed; and an outlet panel accommodated in the box body and including a plurality of outlet sockets exposed through the open side. Connection terminals of the outlet panel are exposed through an opening formed in a bottom portion of the box body. The connection terminals can be connected to output terminals of a generator. A hooking member is adapted to be attachable to an outer surface of the box body so that the box body is hooked on a part of the generator or a peripheral facility of the generator by means of the hooking member. A portable handle is provided on at least one of the box body and the lid.

### BRIEF DESCRIPTION OF THE DRAWINGS

FIG. 1 is a perspective view illustrating a state in which an open side of a generator distribution box is open;

FIG. 2 is a left side view illustrating a state in which a hooking member is attached to the outer surface of a bottom portion of the generator distribution box;

FIG. 3 is a top view illustrating a state in which the hooking member is attached to the outer surface of the bottom portion of the generator distribution box;

FIG. 4 is an enlarged sectional view taken along line A–A in a portion indicated by the arrow line B–B of FIG. 3;

FIG. 5 is a rear view illustrating the generator distribution box as viewed from the outside of the bottom portion;

FIG. 6 illustrates connection terminals of the generator distribution box;

FIG. 7 illustrates the generator distribution box as viewed from the outside of its lower side portion;

FIG. 8 is a partial perspective view illustrating a state in which a sheet member is placed on a part of the outer surface of the bottom portion to which the hooking member is attached;

FIG. 9 is a partial perspective view illustrating a state in which a metal panel is attached to the outer surface of the bottom portion via the sheet member;

FIG. 10 is a partial perspective view illustrating a state in which the hooking member is attached to the outer surface of the bottom portion via the sheet member;

FIG. 11A is a partial perspective view illustrating a state in which an elevating member is attached to the outer surface of the bottom portion via the sheet member;

FIG. 11B is a partial perspective view illustrating a state in which the hooking member is attached to the outer surface of the bottom portion via the sheet member and the elevating member;

FIG. 12 illustrates the inner surface of the bottom portion of a box body;

FIG. 13 illustrates the front side of an outlet panel;

FIG. 14 illustrates the rear side of the outlet panel;

FIG. 15 is a circuit diagram illustrating the mechanism of wiring according to an embodiment;

FIG. 16 is a perspective view illustrating a state in which the generator distribution box is used for a generator;

FIG. 17 illustrates an output terminal board of the generator; and

FIG. 18 illustrates a state in which generator distribution boxes not being used are stacked and stored.

### DETAILED DESCRIPTION

In general, the output terminal board of a generator is provided with a plurality of outlets and a plurality of output terminals, respectively. However, when the generator is installed at a disaster site, an evacuation shelter, or an event venue, a large number of people may require access to power. In such cases, the number of outlets and output terminals provided on the output terminal board of the generator may be insufficient. In these cases, a power strip having a plurality of sockets is connected to an output terminal so as to increase the number of connection ports for power supply destinations.

However, since the generator is often installed in an exposed outdoor state, the area around the generator is frequently uneven ground with poor footing. Accordingly, although it is possible to achieve waterproofing against rainwater and the like by using a waterproof power strip, placing the power strip on the ground around the generator results in the problem of obstructing the movement of people and vehicles in the vicinity of the generator.

In addition, it has been practiced to fix the power strip to the side surface of the generator casing. However, in this case, if the power strip is to be shared among multiple generators according to the usage situation, a great deal of effort is required to remove it from one generator and attach it to another. As a result, in a site where frequent attachment and detachment is required, convenience cannot be ensured.

The present invention is proposed to address the above-described circumstances. That is, the present invention provides a generator distribution box which offers high convenience in that it can avoid being placed on the ground around a generator, allows easy installation on one generator, and ensures good portability when moved from one generator to another.

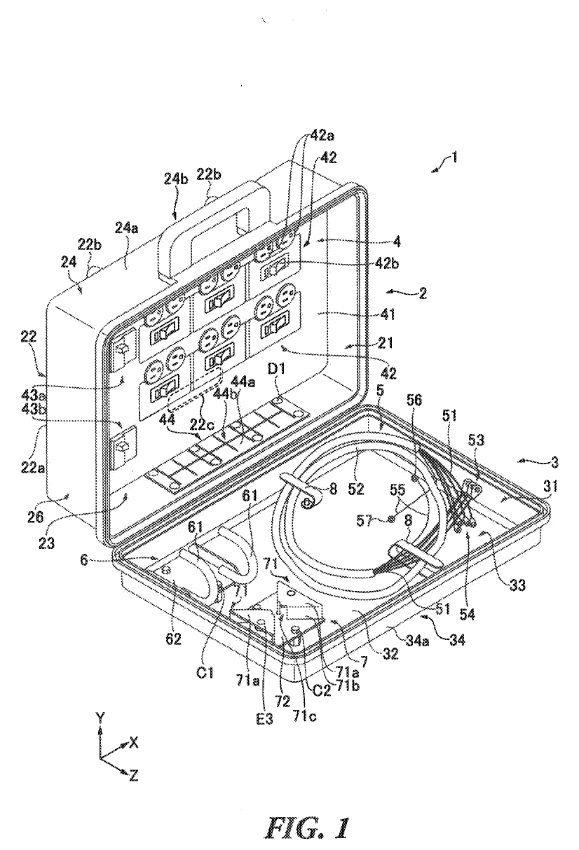

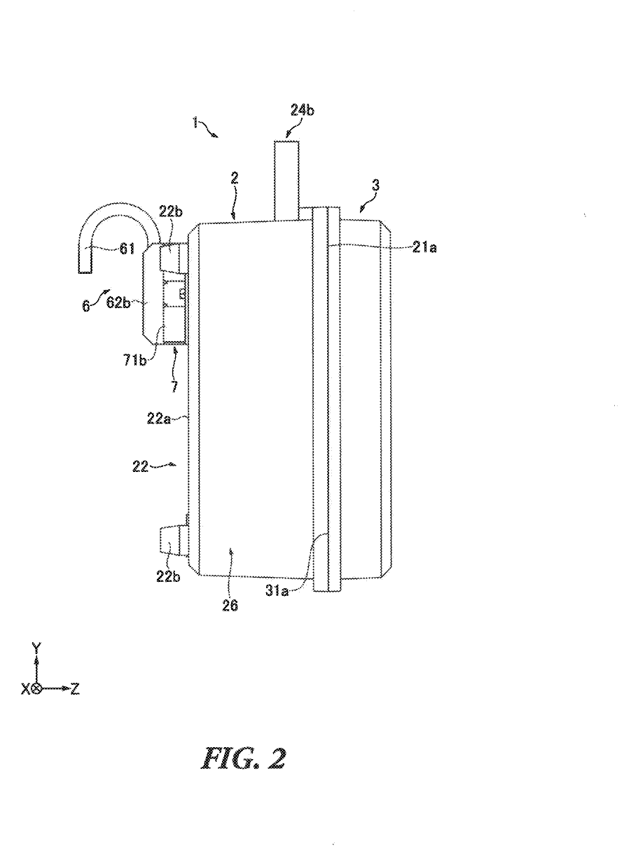

Hereinafter, an embodiment of the present invention will be described with reference to FIG. 1 to FIG. 18. The same reference numbers in the different drawings indicate the same functional parts, and therefore repeated description for each of the drawings is omitted. Herein, the term “upper” of a generator distribution box 1 refers to the direction indicated by arrow Y in the drawings (referred to as “Y-direction”), which corresponds to the upward direction of a box body 2 in its state of use (see FIGS. 1 and 2). The term “lower” of the generator distribution box 1 refers to the reverse direction of the Y-direction, which corresponds to the downward direction of the box body 2 in its state of use (see FIGS. 1 and 2). The term “right” of the generator distribution box 1 refers to the direction indicated by arrow X in the drawings (referred to as “X-direction”), which corresponds to the right-hand direction when the box body 2 is viewed from an open side 21 in its state of use (see FIG. 1). The term “left” of the generator distribution box 1 refers to the reverse direction of the X-direction, which corresponds to the left-hand direction when the box body 2 is viewed from the open side 21 in its state of use (see FIG. 1).

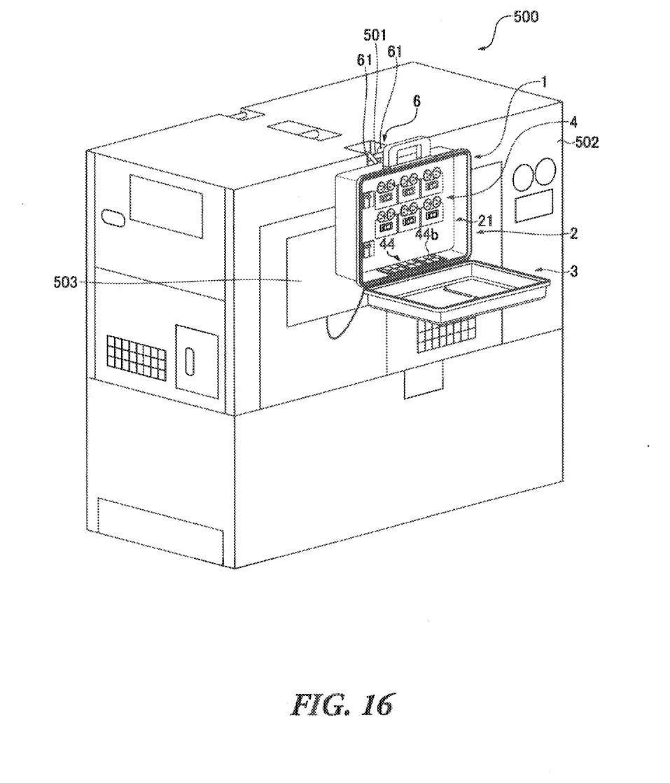

The generator distribution box 1 according to the present embodiment shown in FIG. 1 is used when connected to a generator and configured to increase the number of connection ports for power supply destinations. The generator distribution box 1 is applied to a generator (for example, a generator 500 shown in FIG. 16) that is capable of supplying both three-phase four-wire 200 V (or 220 V) power and single-phase three-wire 100 V (or 110 V) power. The generator distribution box 1 is configured to increase the number of connection ports for power supply destinations (distribution destinations) that receive single-phase 100 V (or 110 V) power from the generator.

As examples of power supply destinations of the three-phase 200 V (or 220 V) power of a generator, large power equipment may be cited, such as compressors and large refrigerators used in factories, or belt conveyors and construction elevators used at construction sites.

On the other hand, examples of power consumers of the single-phase 100 V (or 110 V) power of a generator include electric devices such as lighting equipment, heaters, fans, chargers for mobile terminals such as smartphones, and electric cooking appliances, which are used at disaster sites, evacuation facilities, event venues, and the like.

As shown in FIG. 1, the generator distribution box 1 according to the present embodiment includes the box body 2, a lid 3, and an outlet panel 4 accommodated in the box body 2. The box body 2 includes the open side 21. The box body 2 also includes a bottom portion 22 forming the bottom of the box shape on the side opposite to the open side 21 in the direction indicated by arrow Z in the drawings “referred to as “Z-direction”). This box body 2 includes a first accommodating section 23 formed between the open side 21 and the bottom portion 22.

The lid 3 is mounted to the box body 2 so as to open or close the open side 21 of the box body 2. As shown in FIG. 2, the lid 3 may be mounted to the box body 2 via a hinge (not shown) that connects one edge of an open-side end portion 21a of the box body 2 and one edge of an open-side end portion 31a of the lid 3. In this case, the lid 3 rotates around the hinge with respect to the box body 2 to open or close the open side 21.

It should be understood that the structure for mounting the lid 3 to the box body 2 may be implemented in other configurations. For example, the lid 3 may have a structure that allows it to be detachably attached to the box body 2. In this case, for example, the lid 3 may be mounted to the box body 2 by means of a fixing portion (not shown) provided on the lid 3.

As shown in FIG. 1, the outlet panel 4 is accommodated in the first accommodating section 23 of the box body 2. The lid 3 defines a second accommodating section 33 between its opening 31 and its inner surface 32. The second accommodating section 33 accommodates a connection cable 5, a hooking member 6, and an elevating member 7.

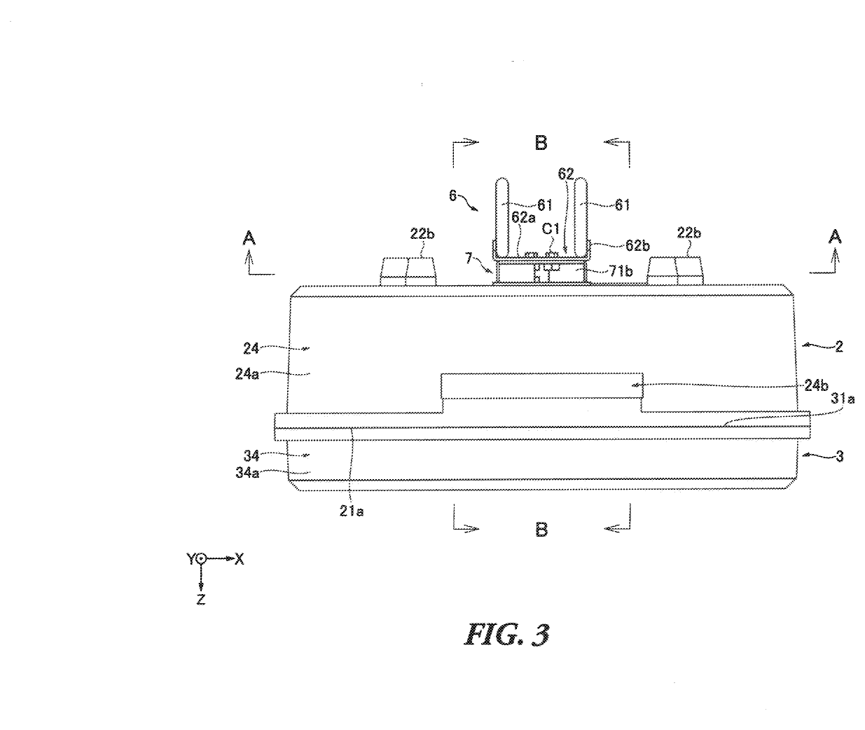

As shown in FIG. 1 and FIG. 3, a portable handle 24b is provided on an outer surface 24a of an upper side portion 24 (referred to as “upper outer surface 24a”) of the box body 2 so as to stand upright from the upper outer surface 24a in the upward direction (Y-direction) of the box body 2. Here, the portable handle 24b may not be provided on the upper outer surface 24a of the box body 2, but be provided on an outer surface 34a of an upper side portion 34 (referred to as “upper outer surface 34a”) of the lid 3 so as to stand upright from the upper outer surface 34a in the upward direction (Y-direction) of the box body 2.

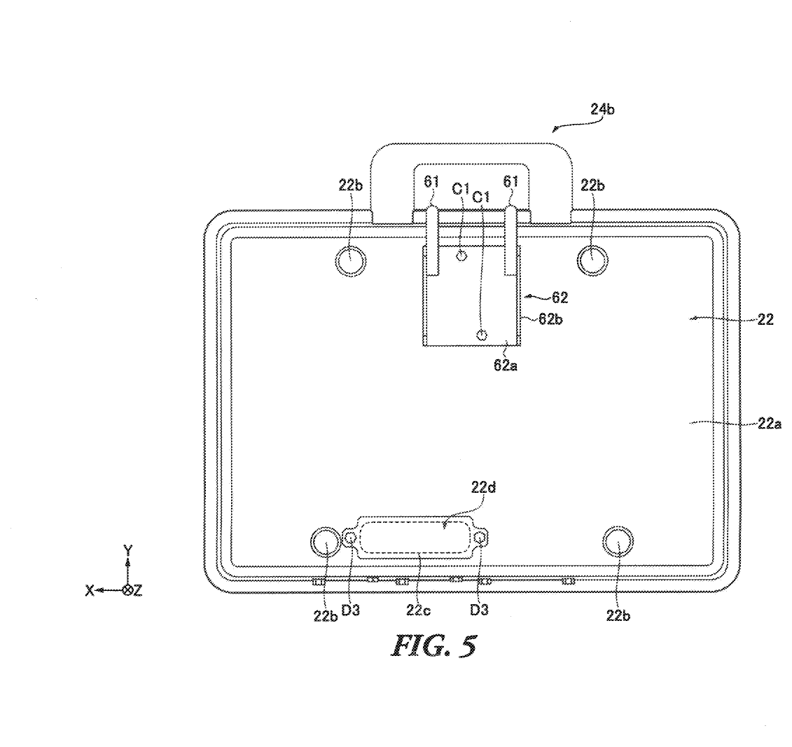

Otherwise, portable handles 24b may be provided on both the upper outer surface 24a of the box body 2 and the upper outer surface 34a of the lid 3. That is, the generator distribution box 1 may include two portable handles 24b, one of which stands upright from the upper outer surface 24a in the upward direction (Y-direction) of the box body 2, and the other of which stands upright from the upper outer surface 34a in the upward direction (Y-direction) of the box body 2. As shown in FIGS. 1 and 5, four protruding legs 22b are provided on an outer surface 22a of a bottom portion (referred to as “bottom outer surface 22a”) of the box body 2 in a distributed arrangement. Each of the protruding legs 22b is provided to stand upright from the bottom outer surface 22a in the reverse direction of the Z-direction.

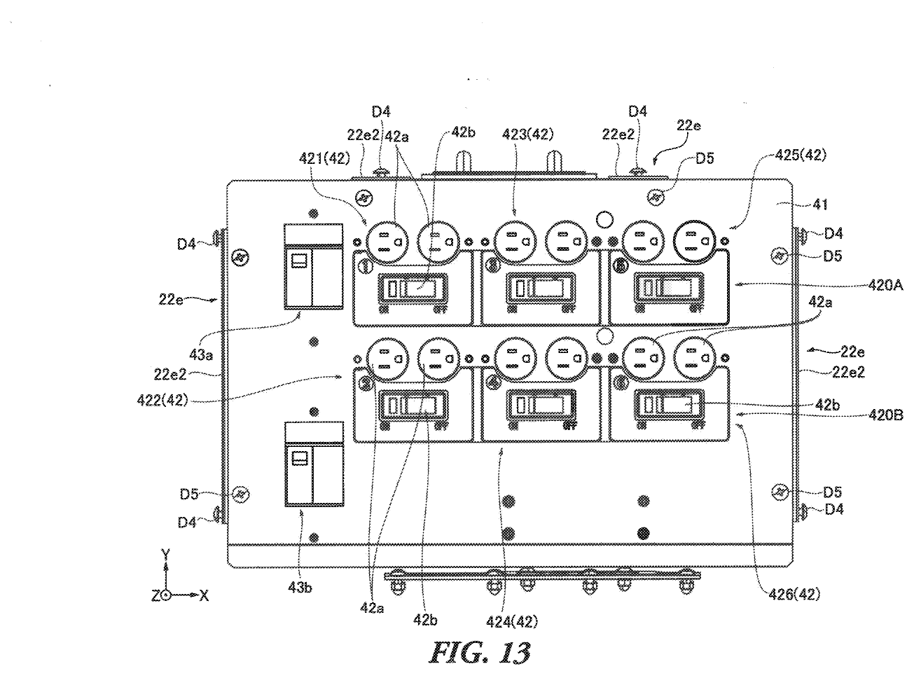

As shown in FIG. 1 and FIG. 13, the outlet panel 4 includes a total of six outlet sets 42 arranged in two rows—three in an upper row and three in a lower row on a front surface 41 facing in the Z-direction. Each of the outlet sets 42 includes, for example, two outlet sockets 42a rated for 100 V (or 110 V), and a breaker switch 42b connected to these two outlet sockets 42a. The outlet panel 4 also includes, on its front surface 41, a sub-breaker switch 43a connected to the three outlet sets 42 arranged in the upper row, which constitute a first group 420A shown in FIG. 13, and a sub-breaker switch 43b connected to the three outlet sets 42 arranged in the lower row, which constitute a second group 420B shown in FIG. 13. A total of twelve outlet sockets 42a provided in the outlet panel 4 are exposed through the open side 21 when the open side 21 is open.

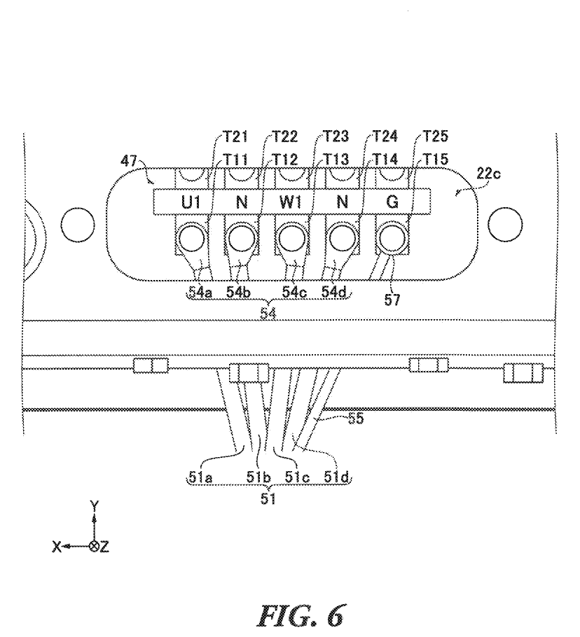

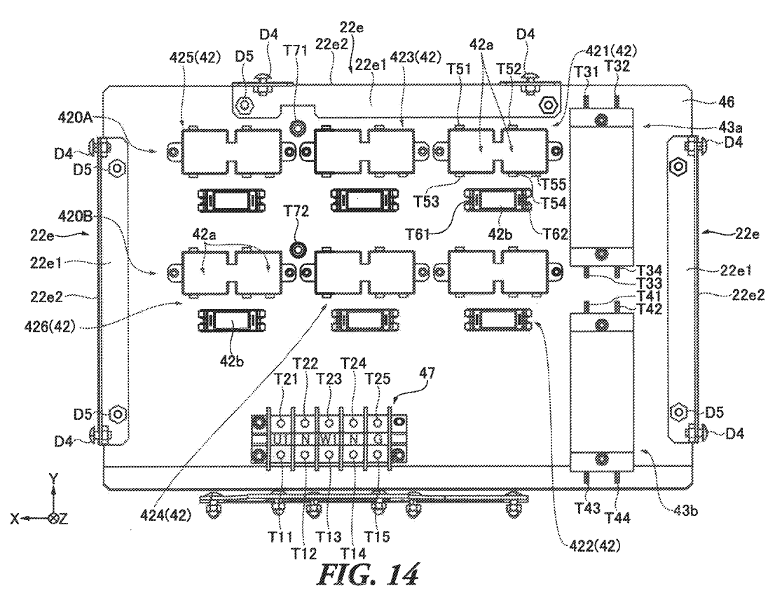

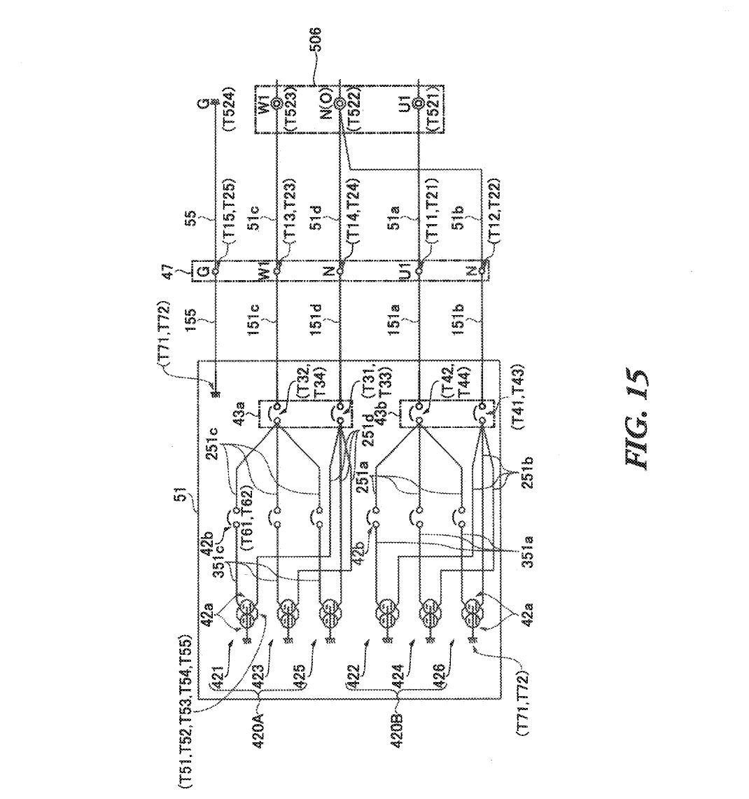

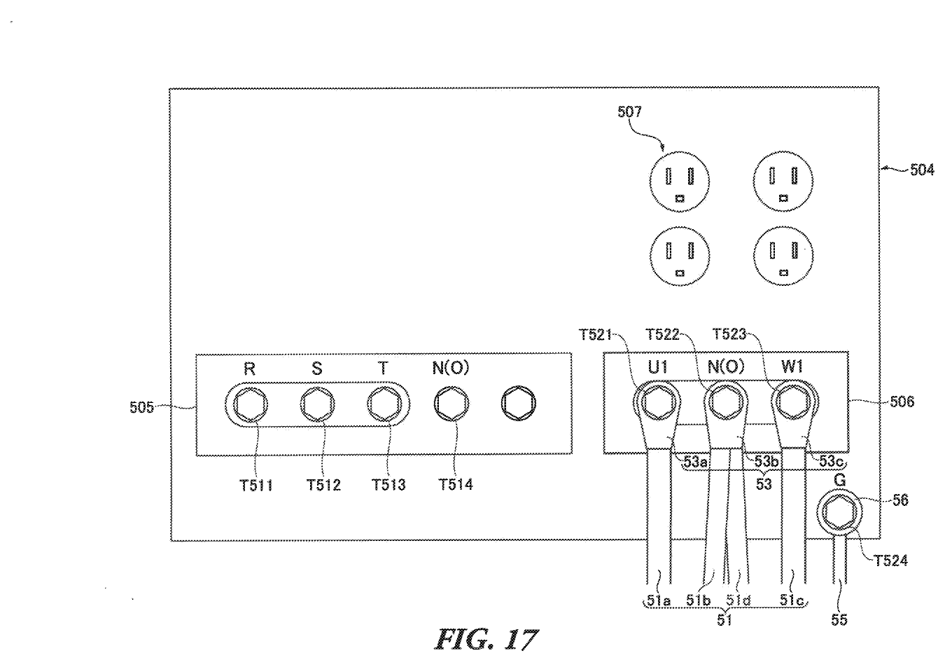

On a rear surface 46 of the outlet panel 4 including the plurality of outlet sockets 42a, which faces in the direction opposite to the Z-direction, a terminal section 47 is provided, as shown in FIGS. 6 and 14. The terminal section 47 includes, for example, connection terminals T11 to T14, an external ground (earth) terminal (G)T15, connection terminals T21 to T24, and an external ground (earth) terminal (G)T25. The connection terminals T11 to T14 can be connected, via multiple cable wires 51a to 51d of the connection cable 5, to output terminals T521 to T523 (FIG. 17) provided on a generator 500 as an example of a generator (FIG. 16). In addition, an external ground terminal (G)T15 can be connected to an external ground (earth) terminal (G)T524 (FIG. 17) of the generator 500 (FIG. 16) via an earth wire 55. The connection terminals T21 to T24 and the external ground terminal (G)T25 are connected to corresponding terminals provided on the rear surface 46 of the outlet panel 4, via internal cable wires 151a to 151d and an internal earth wire 155 (see FIG. 15).

The connection cable 5 is an elongated cable formed by bundling the multiple cable wires 51 using an insulating member 52. The connection cable 5 is formed by bundling the earth wire 55 together with the multiple cable wires 51 using the insulating member 52. As shown in FIG. 1, the connection cable 5 is accommodated in the second accommodating section 33 of the lid 3 in a wound state, and is pressed against the inner surface 32 of the lid 3 by a retainer 8 fixed to the inner surface 32, so that the wound state of the connection cable 5 is maintained. The connection cable 5 exposes, from both ends of the insulating member 52, cable terminals 53 and 54 at both ends of the cable wires 51, and external ground (earth) terminals (G)56 and 57 at both ends of the earth wire 55. A cable terminal 53 of each of the cable wires 51 is connected to a corresponding one of multiple output terminals provided in the generator. Meanwhile, a cable terminal 54 of each of the cable wires 51 is connected to a corresponding one of the connection terminals T11 to T14 (FIGS. 6 and 14) in the terminal section 47 on the rear surface 46 of the outlet panel 4. An external ground terminal (G)56 of the earth wire 55 is connected to an external ground terminal of the generator. Meanwhile, an external ground terminal (G)57 of the earth wire 55 is connected to the external ground terminal (G)T15 (FIGS. 6 and 14) in the terminal section 47 provided on the rear surface 46 of the outlet panel 4.

In this way, the outlet panel 4 of the generator distribution box 1 is connected to the generator via the connection cable 5. By this means, it is possible to supply the power of the generator to the outlet panel 4 of the generator distribution box 1.

According to the generator distribution box 1 of the present embodiment, the hooking member 6 is attached to the bottom outer surface 22a of the box body 2 via the elevating member 7, as shown in FIGS. 2 to 4. That is, the hooking member 6 and the elevating member 7 are stacked and attached in the order of the elevating member 7 and the hooking member 6 in a direction perpendicular to the bottom outer surface 22a of the box body 2 (in the direction opposite to the Z-direction). The box body 2 of the generator distribution box 1 can be hooked onto a part of the generator (for example, the generator 500 shown in FIG. 16) or a peripheral facility (not shown) of the generator by means of the hooking member 6 attached as described above.

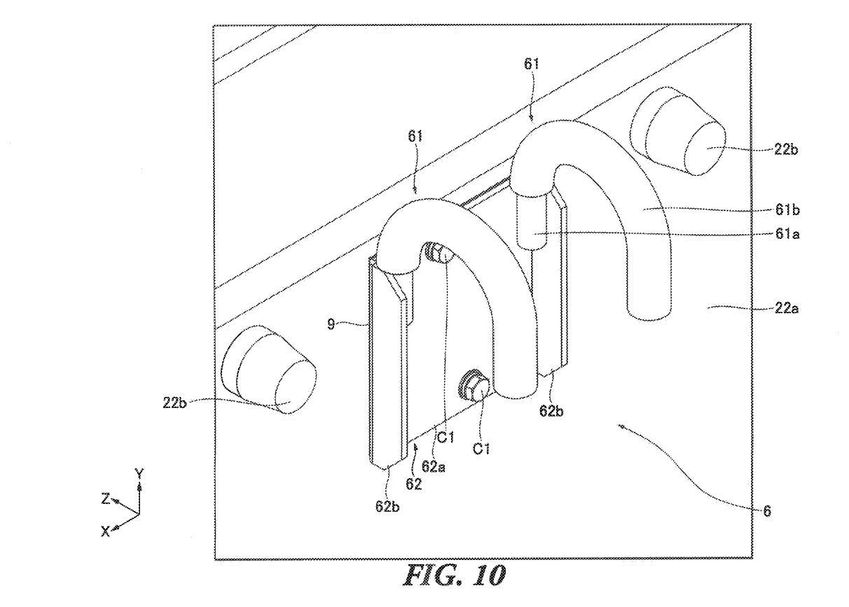

Hooks 61 are members configured to hook the box body 2 onto a part of the generator 500 or a peripheral facility of the generator 500. For example, as shown in FIG. 10, each of the hooks 61 is formed of a metallic rod 61a (for example, made of iron) that is curved into an approximately U-shaped configuration, and an insulating member 61b (for example, a rubber tube) that covers part of the rod 61a.

Each of the rods 61a of the two hooks 61, which are not covered with the insulating member 61b, is attached to a mounting portion 62 by welding or the like. As a result, the hooking member 6, in which the two hooks 61 are integrated with the mounting portion 62, is formed. The mounting portion 62 of the hooking member 6 is configured to mount the two hooks 61 to the bottom outer surface 22a. For example, as shown in FIGS. 3, 5, and 10, the mounting portion 62 includes a rectangular mounting plate 62a to which the two hooks 61 are attached by welding or the like, and a pair of support portions 62b that are bent substantially perpendicular to the mounting plate 62a at both widthwise ends thereof to support the two hooks 61.

When the generator distribution box 1 is in use, the curved portions of the two hooks 61 of the hooking member 6 are hooked onto a hooking member (e.g., a bar member 501 shown in FIG. 16) that is part of the generator or a hooking member of a peripheral facility of the generator. As a result, the box body 2 can be hooked on a part of the generator or a peripheral facility of the generator.

When the hooking member 6 is accommodated in the second accommodating section 33 as shown in FIG. 1, the hooking member 6 is fastened to the inner surface 32 of the lid 3 by inserting fastening members C1 such as bolts into two holes (not shown) formed in the mounting portion 62 and tightening them. As a result, the hooking member 6 is fixed to the inner surface 32 of the lid 3.

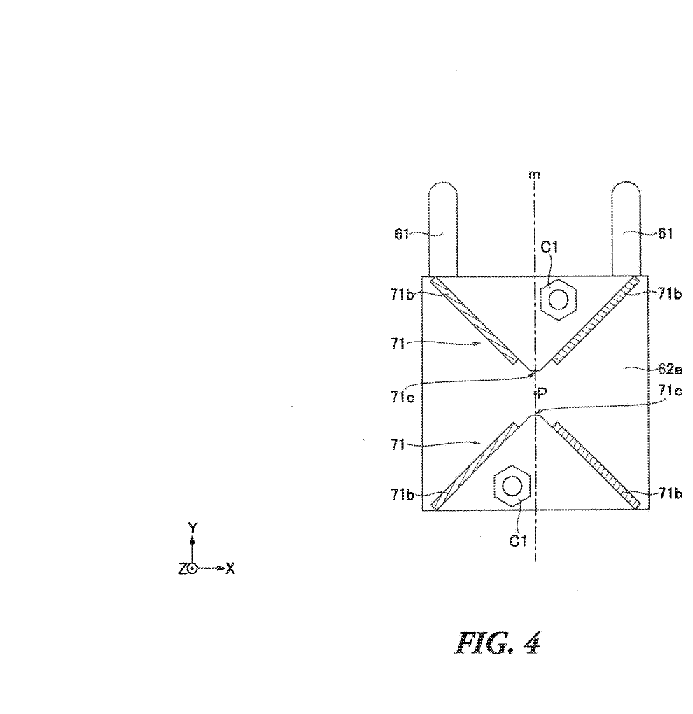

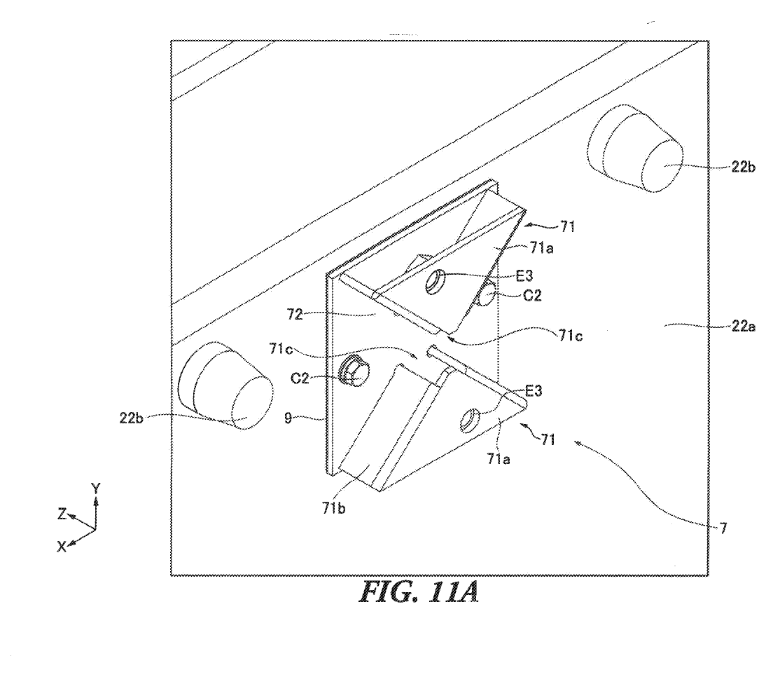

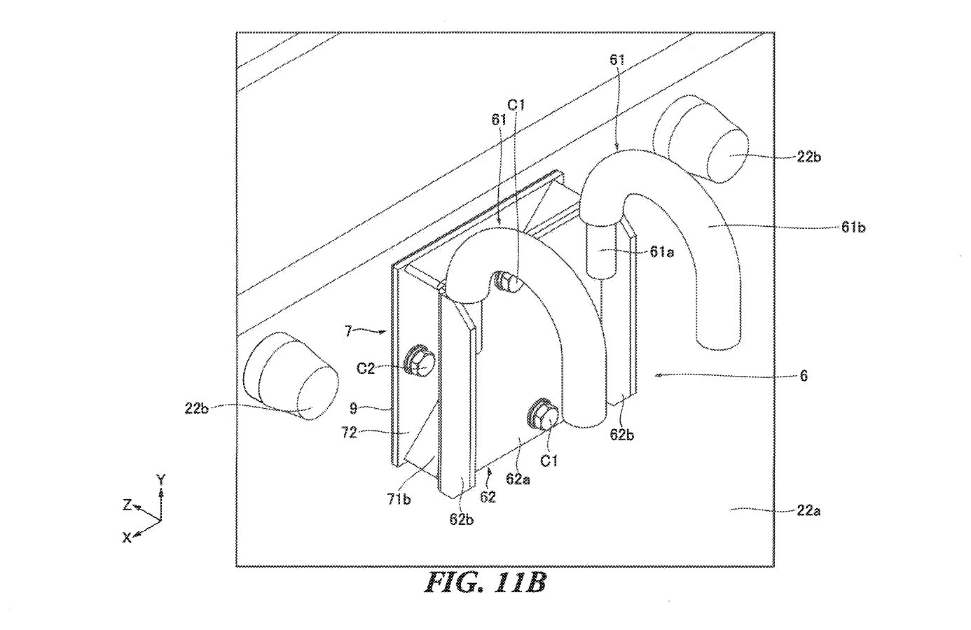

For example, as shown in FIG. 1, and FIG. 4 which is an enlarged sectional view taken along line A–A in the portion indicated by the arrow line B–B of FIG. 3, the elevating member 7 is formed by coupling two elevating block members 71, which serve to elevate the hooks 61, to a rectangular metal mounting plate 72. Each of the elevating block members 71 includes a mounting surface 71a (FIGS. 1 and 11A) to mount the mounting portion 62, and two elevation surfaces 71b (see FIGS. 1 to 4, and 11A) continuous with the mounting surface 71a. The mounting surface 71a is tapered toward the center of the mounting plate 72 and has a substantially triangular shape. As shown in FIG. 2, the elevation surface 71b has an elevation height extending vertically outward (in the direction opposite to the Z-direction) from the bottom outer surface 22a, so as to raise the mounting position of the hooking member 6 above the bottom outer surface 22a. In addition, as shown in FIG. 4, each of the elevation surfaces 71b is inclined with respect to center line m in the width direction of the elevation block member 71. The elevating block member 71 has a tapered end (i.e., the end located toward the center of the mounting plate 72) that is open rather than closed, thereby forming an opening 71c. The two elevating block members 71 are arranged substantially symmetrically with respect to center point P (FIG. 4) of the mounting plate 72, such that their tapered ends (i.e., the sides having the openings 71c) face each other.

Because the elevating block member 71 has the above-described shape, even if water such as rainwater enters the upper one of the two elevating block members 71, the water flows down along the inclined inner surface of the elevation surface 71b and drains into the opening 71c. The water that has flowed down then either quickly flows through the inside of the lower elevating block member 71 via the opening 71c, or flows along the inclined outer surface of the elevation surface 71b of the lower elevating block member 71. With the two elevating block members 71 having the above-described configuration, the elevating member 7 can quickly discharge water such as rainwater to the outside.

The hooking member 6 is attached to the elevating member 7 with the fastening members C1 such as bolts. The positions at which the elevating member 7 is attached to the hooking member 6 (i.e., the positions of the holes E3 (FIG. 1) formed in the elevating block members 71) are provided one on each side of the centerline m in the width direction of the elevating block members 71 as shown in FIG. 4.

This allows an operator of the generator distribution box 1 to fasten the hooking member 6 to the elevating member 7 in the correct direction without making an error in the fastening orientation. Specifically, the operator of the generator distribution box 1 can align the holes E3 (FIG. 1) of the two elevating block members 71 with the holes (not shown) formed in the mounting portion 62 of the hooking member 6, and fasten the hooking member 6 to the elevating member 7 by inserting and rotating the fastening members C1 such as bolts (FIGS. 1 and 4) in the holes.

When the elevating member 7 is accommodated in the second accommodating section 33 as shown in FIG. 1, the elevating member 7 is fastened to the inner surface 32 of the lid 3 by inserting and rotating fastening members C2 such as bolts in two holes (not shown) formed in the mounting plate 72. As a result, the elevating member 7 is fixed to the inner surface 32 of the lid 3.

As shown in FIGS. 1 and 5, an opening 22c, as illustrated in FIG. 6, is formed at an arbitrary position near the lower end in the vertical direction (the Y-direction and the reverse direction of the Y-direction) on the bottom outer surface 22a of the box body 2. As shown in FIG. 6, the connection terminals T11 to T14, the external ground terminal (G)T15, the connection terminals T21 to T24, and the external ground terminal (G)T25 of the terminal section 47 are exposed through the opening 22c formed on the bottom outer surface 22a. For example, when the operator of the generator distribution box 1 connects or disconnects cable terminals 54a to 54d of the cable wires 51 and the external ground terminal (G)57 of the earth wire 55 to or from the connection terminals T11 to T14 and the external ground terminal (G)T15 of the terminal section 47, the operator can easily perform the operation by inserting a tool or the like into the opening 22c from outside the box body 2.

The operator may appropriately cover the opening 22c with a metal panel 22d as shown in FIG. 5, when the above-described operation is not being performed, and may fasten the metal panel 22d to the bottom outer surface 22a with fastening members D3 such as bolts to close the opening 22c. This configuration prevents foreign matter such as dust and debris, and water such as rainwater, from entering the inside of the box body 2 from the outside and adhering to the connection terminals T11 to T14, the external ground terminal (G)T15, the connection terminals T21 to T24, and the external ground terminal (G)T25 of the terminal section 47.

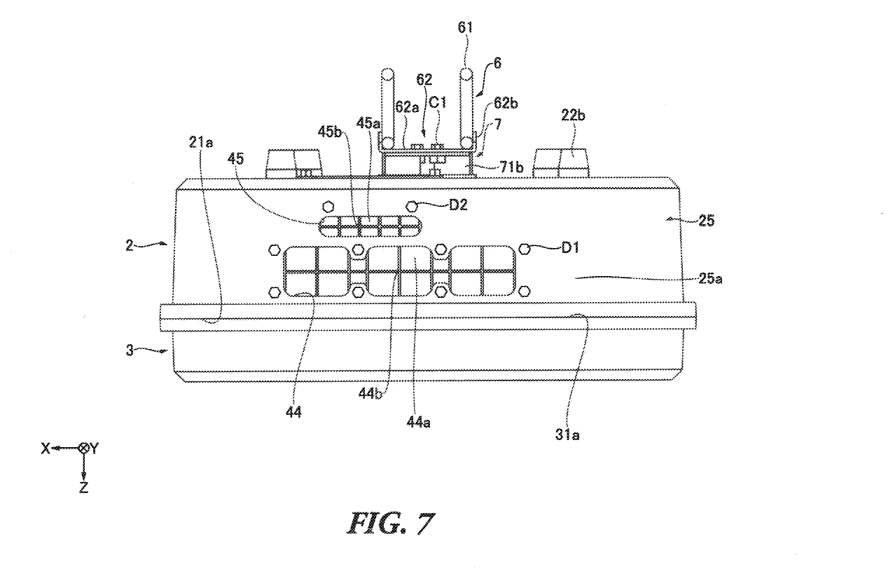

As shown in FIGS. 1 and 7, a lead-in hole 44 for introducing a power cord (not shown) of a power supply destination (an electrical device) to the front surface 41 of the outlet panel 4 in the first accommodating section 23 is formed in the outer surface 25a of the lower side portion 25 of the box body 2. An insulating member 44a such as a rubber member is provided on the lead-in hole 44. The insulating member 44a is fastened to the inner surface of the lower side portion 25 with fastening members D1 such as bolts, thereby being provided on and covering the lead-in hole 44. A plurality of slits 44b for introducing power cords of the power supply destination are formed in the insulating member 44a. By providing the insulating member 44a such as a rubber member on the lead-in hole 44, it is possible to prevent foreign matter such as dust and debris, and water such as rainwater from entering the front surface 41 of the outlet panel 4 in the first accommodating section 23, from the outside of the outer surface 25a of the lower side portion 25.

In addition, as shown in FIG. 7, a lead-out hole 45 is formed in the lower side portion 25 of the box body 2 for leading out the connection cable 5 having the cable wires 51 connected to the connection terminals T11 to T14 of the terminal section 47 to the outside of the box body 2. An insulating member 45a such as a rubber member is provided on the lead-out hole 45. The insulating member 45a is fastened to the inner surface of the lower side portion 25 with fastening members D2 such as bolts, thereby being provided on and covering the lead-out hole 45. Slits 45b for leading out the connection cable 5 are formed in the insulating member 45a. By providing the insulating member 45a as a rubber member on the lead-out hole 45, it is possible to prevent foreign matter such as dust and debris, and water such as rainwater from entering the rear surface 46 of the outlet panel 4 in the first accommodating section 23, from the outside of the outer surface 25a of the lower side portion 25.

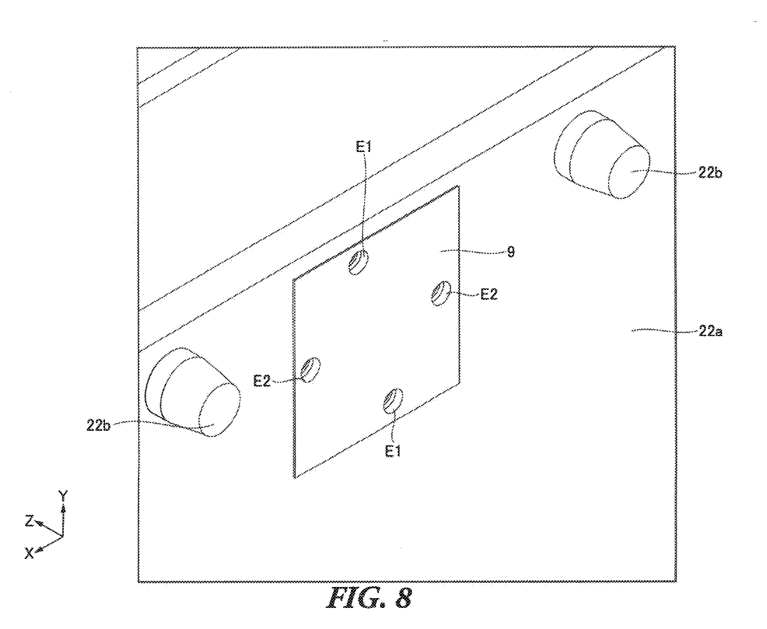

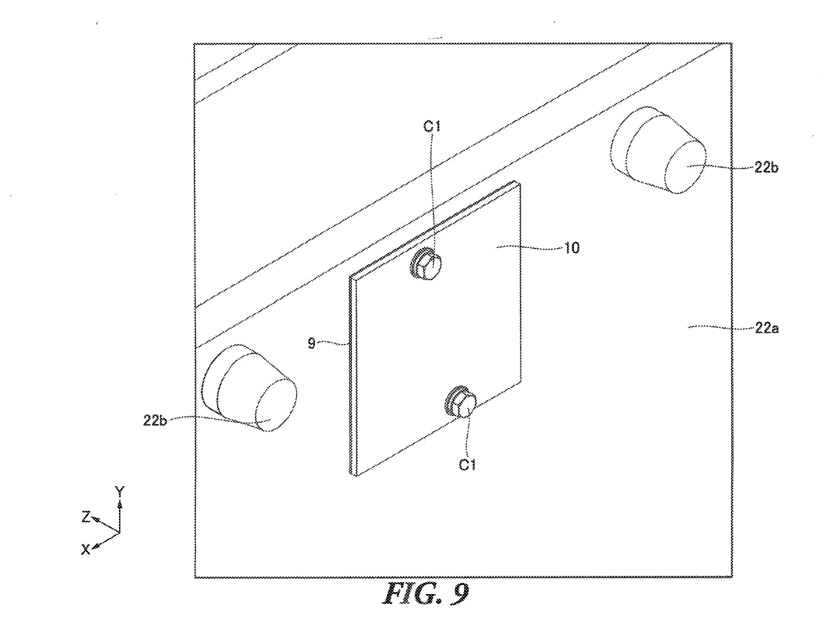

When the hooking member 6 is not mounted to the box body 2, a portion of the bottom outer surface 22a where the hooking member 6 is to be attached may be closed from the outside. In this case, for example, as shown in FIG. 8, a sheet member 9 having two holes E1 and two hole E2 is placed on the portion of the bottom outer surface 22a where the hooking member 6 is to be attached. After that, as shown in FIG. 9, a metal panel 10 having two holes (not shown) is placed on the sheet member 9. The metal panel 10 is attached to the bottom outer surface 22a by passing fastening members C1 such as bolts through the holes E1 and corresponding holes (not shown) of the metal panel 10, inserting and rotating them in corresponding holes (not shown) of the bottom outer surface 22a. The sheet member 9 may be, for example, a sponge sheet, but is not limited, and may be any other sheet-like member.

As described above, when the hooking member 6 is not mounted to the box body 2, the portion of the bottom outer surface 22a where the hooking member 6 is to be attached is covered with the metal panel 10, thereby closing the holes (not shown) formed in that portion with the metal panel 10. By this means, it is possible to prevent foreign matter such as dust and debris, and water such as rainwater from entering the inside of the box body 2 from the outside via the holes.

Moreover, as described above, by fastening the metal panel 10 onto the bottom outer surface 22a via the sheet member 9, it is possible to prevent the metal panel 10 from contacting the bottom outer surface 22a, thereby preventing the bottom outer surface 22a from being damaged. Furthermore, by providing the sheet member 9 on the bottom outer surface 22a, it is possible to prevent water such as rainwater from entering the inside of the box body 2 from the outside, thereby achieving a waterproof effect. Alternatively, the metal panel 10 may be directly fixed to the bottom outer surface 22a without interposing the sheet member 9.

The hooking member 6 may be mounted to the box body 2 either alone or together with the elevating member 7.

That is, the hooking member 6 can be attached to the bottom outer surface 22a without interposing the elevating member 7. However, to ensure that the hooks 61 properly engage with the hooking member (for example, the bar member 501 shown in FIG. 16) of the generator, it is preferable that the hooking member 6 be attached to the bottom outer surface 22a via the elevating member 7, as shown in FIGS. 2 to 4.

When the hooking member 6 is attached to the bottom outer surface 22a without interposing the elevating member 7, the sheet member 9 is placed on the portion of the bottom outer surface 22a where the hooking member 6 is to be attached, for example, as shown in FIG. 8. After that, as shown in FIG. 10, the hooking member 6 having two holes (not shown) is placed on the sheet member 9. The fastening members C1 such as bolts are inserted through the holes E1 and the corresponding holes (not shown) of the hooking member 6 and then rotated, thereby fastening the hooking member 6 to the bottom outer surface 22a.

Meanwhile, when the hooking member 6 is attached to the bottom outer surface 22a via the elevating member 7, the sheet member 9 is placed on the portion of the bottom outer surface 22a where the hooking member 6 is to be attached, for example, as shown in FIG. 8. After that, as shown in FIG. 11A, the elevating member 7 is placed on the sheet member 9. Fastening members C2 such as bolts are inserted through the holes E2 (FIG. 8) of the sheet member 9 and corresponding holes (not shown) of the mounting plate 72 and then rotated, thereby fastening the elevating member 7 to the bottom outer surface 22a.

After that, as shown in FIG. 11B, the hooking member 6 having two holes (not shown) is placed on the elevating member 7. The fastening members C1 such as bolts are inserted through holes (not shown) of the mounting plate 62a and holes E3 (FIG. 11A) of the elevating member 7 and then rotated, thereby fastening the hooking member 6 to the elevating member 7. As a result, the hooking member 6 is attached to the bottom outer surface 22a via the elevating member 7 (and the sheet member 9).

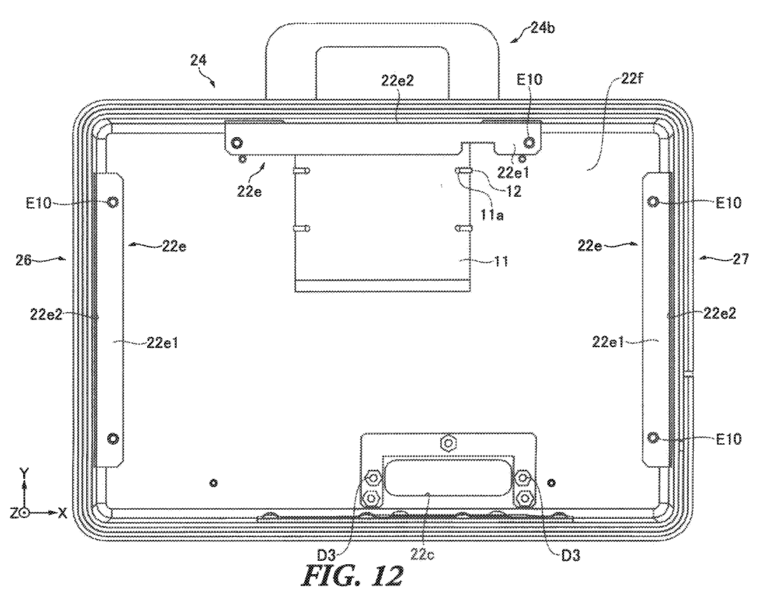

The outlet panel 4 is supported by support fixing members 22e shown in FIG. 12, and accommodated in the first accommodating section 23 of the box body 2 while being fixed to the box body 2 via the support fixing members 22e. To be more specific, as shown in FIG. 12, support fixing members 22e are respectively mounted on the inner surfaces of the upper side portion 24 on the Y-direction side, a left side portion 26 on the side opposite to the X-direction, and a right side portion 27 on the X-direction side of the box body 2. The support fixing members 22e support the outlet panel 4 accommodated in the first accommodating section 23 and fixes it to the box body 2. In FIG. 13, the support fixing members 22e are shown together with the front surface 41 of the outlet panel 4, and in FIG. 14, the support fixing members 22e are shown together with the rear surface 46 of the outlet panel 4 for explanation purposes.

As shown in FIGS. 12 to 14, the three support fixing members 22e each have a supporting surface 22e1 that supports the outlet panel 4 and a fixing surface 22e2. One of the fixing surfaces 22e2 is secured to the inner surface of the upper side portion 24, another to the inner surface of the left side portion 26, and the remaining one to the inner surface of the right side portion 27. Each of the support fixing members 22e is fastened to the upper side portion 24, the left side portion 26, and the right side portion 27 of the box body 2 by inserting fastening members D4 such as bolts through two holes (not shown) formed in each of the fixing surface 22e2 and corresponding holes (not shown) formed in the respective portions, and then tightening the fastening members D4.

Then, the outlet panel 4 is fastened to the supporting surfaces 22e1 by fastening members D5 (FIGS. 13 and 14) such as bolts, which are inserted through two holes (not shown) formed in each of the upper end, the left end and the right end of the outlet panel 4, and two holes E10 (FIG. 12) formed in the supporting surface 22e1 of each of the three support fixing members 22e. As a result, the outlet panel 4 accommodated in the first accommodating section 23 is fixed to the box body 2 via the support fixing members 22e.

As shown in FIG. 12, the portion of an inner surface 22f of the bottom portion 22 (referred to as “bottom inner surface 22f”) of the box body 2 that corresponds to the rear side of the mounting position of the hooking member 6 may be covered with an insulating sheet 11. The material for forming the insulating sheet 11 is not particularly limited, but may be, for example, plastic. The insulating sheet 11 is fixed to the bottom inner surface 22f by retainers 12 passed through holes 11a.

Internal cables and the like (not shown) are provided on the rear surface 46 side of the outlet panel 4. In the generator distribution box 1, therefore, the portion of the bottom inner surface 22f of the box body 2 that corresponds to the rear side of the mounting position of the hooking member 6 is covered with the insulating sheet 11. Accordingly, in the portion of the bottom inner surface 22f that corresponds to the rear side of the mounting position of the hooking member 6, the tips of the fastening members C1 and C2 such as bolts projecting toward the bottom inner surface 22f do not contact the internal cables. As a result, it is possible to prevent the internal cables from being damaged. Moreover, since the insulating sheet 11 is made of an insulating material such as plastic, electric shock and electric leakage can be prevented.

Hereinafter, the detailed configuration of the outlet panel 4 will be described. As shown in FIGS. 13 and 14, which illustrate the front surface 41 and the rear surface 46, respectively, the outlet panel 4 includes the six outlet sets 42 (FIG. 1), namely first to sixth outlet sets 421 to 426, which have the same configuration. The first outlet set 421, the third outlet set 423, and the fifth outlet set 425 are provided in the upper low of the outlet panel 4, as a first group 420A of the outlet sets 42. Meanwhile, the second outlet set 422, the fourth outlet set 424, and the sixth outlet set 426 are provided in the lower row of the outlet panel 4, as a second group 420B of the outlet sets 42.

The breaker switch 42b provided for each of the outlet sets 42 switches its state from ON to OFF to cut off the circuit when the current flowing through the two outlet sockets 42a exceeds a predetermined value (for example, 30 A). By this means, even if the circuit of one of the outlet sets 42 is shut off, the circuits of the other outlet sets 42 remain active, so that the number of outlet sockets 42a that become temporarily unusable can be minimized.

A sub-breaker switch 43a disposed in the upper row of the outlet panel 4 switches its state from ON to OFF to cut off the circuit when the current flowing through the total of six outlet sockets 42a of the first group 420A (including the first, third, and fifth outlet sets 421, 423, and 425) disposed in the upper row of the outlet panel 4 exceeds a predetermined value (for example, 100 A). By this means, even if the circuits of the three outlet sets 42 belonging to the first group 420A disposed in the upper row of the outlet panel 4 are shut off, the circuits of the three outlet sets 42 belonging to the second group 420B disposed in the lower row of the outlet panel 4 remain active, so that the number of outlet sockets 42a that become temporarily unusable can be minimized.

Likewise, a sub-breaker switch 43b disposed in the lower row of the outlet panel 4 switches its state from ON to OFF to cut off the circuit when the current flowing through the total of six outlet sockets 42a of the second group 420B (including the second, forth, and sixth outlet sets 422, 424, and 426) disposed in the lower row of the outlet panel 4 exceeds a predetermined value (for example, 100 A). By this means, even if the circuits of the three outlet sets 42 belonging to the second group 420B disposed in the lower row of the outlet panel 4 are shut off, the circuits of the three outlet sets 42 belonging to the first group 420A disposed in the upper row of the outlet panel 4 remain active, so that the number of outlet sockets 42a that become temporarily unusable can be minimized.

As shown in FIG. 13, identification numbers visible to the user are provided on the front surface 41 of the outlet panel 4. Specifically, odd numbers “1”, “3”, and “5” are assigned to the first, third, and fifth outlet sets 421, 423, and 425 of the first group 420A disposed in the upper row (first row), respectively, while even numbers “2”, “4”, and “6” are assigned to the second, forth, and sixth outlet sets 422, 424, and 426 of the second group 420B disposed in the lower row (second row), respectively. Thus, in the outlet panel 4, numbers are assigned to the six outlet sets 42 in an alternating sequence between the outlet sets 42 of the first group 420A located in the upper row and those of the second group 420B located in the lower row.

By assigning the numbers in this manner, it is possible to prevent a user from preferentially using the outlet sockets 42a of the first group 420A disposed in the upper row of the outlet panel 4. As a result, the numbering arrangement prevents a condition in which the sub-breaker switch 43a connected to the first, third, and fifth outlet sets 421, 423, and 425 of the first group 420A is more likely to be turned off.

As shown in FIG. 14, the outlet panel 4 is provided, on the lower end side of the rear surface 46 (i.e., in the direction opposite to the Y-direction), with the terminal section 47 including the connection terminals T11 to T14, the external ground terminal (G)T15, the connection terminals T21 to T24, and the external ground terminal (G)T25 described with reference to FIG. 6. Also, as shown in FIG. 14, the sub-breaker switches 43a and 43b are provided on the rear surface 46 of the outlet panel 4. The sub-breaker switch 43a includes terminals T31 to T34, and the sub-breaker switch 43b includes terminals T41 to T44. In one outlet set 42, terminals T51 to T54 and an external ground terminal (G)T55 are provided on side surfaces of the housings of the two outlet sockets 42a, and terminals T61 and T62 are provided at both ends of the breaker switch 42b in the longitudinal direction.

The connection cable 5 and a number of internal cable wires are connected to these terminals shown in FIG. 14. In the present embodiment, by virtue of the wiring configuration shown in the circuit diagram of FIG. 15, single-phase 100 V (or 110 V) power from a generator (for example, the generator 500 shown in FIG. 16) is supplied to the twelve outlet sockets 42a provided in the outlet panel 4.

The connection cable 5 provided in the generator distribution box 1 can be connected to the generator 500 shown in FIG. 16. As one example, the generator 500 is provided with an output terminal board (power panel) 504 shown in FIG. 17, on its side surface 502. For example, as shown in FIG. 16, the output terminal board 504 may be covered with an openable lid 503 that prevents intrusion of foreign matter such as dust or debris, or water such as rainwater, from outside. As shown in FIG. 17, the output terminal board 504 may be provided, as one example, with a three-phase terminal section 505 for three-phase four-wire 200 V (or 220 V) power, a single-phase terminal section 506 for single-phase three-wire 100 V (or 110 V) power, and four outlet sockets 507 for 100 V (or 110 V) power.

In the output terminal board 504 shown in FIG. 17, the three-phase terminal section 505 may include output terminals T511 (voltage phase R), T512 (voltage phase S), T513 (voltage phase T), and T514 (neutral phase N(O)) as output terminals for three-phase four-wire 200 V (or 220 V) power. The single-phase terminal section 506 may include output terminals T521 (voltage phase U1), T522 (neutral phase N(O)), and T523 (voltage phase W1) as output terminals for single-phase three-wire 100 V (or 110 V) power. Moreover, the output terminal board 504 may include an external ground terminal (G)T524.

As shown in FIGS. 6 and 17, the connection cable 5 includes four cable wires 51 including the cable wire 51a for connection to the U1-phase terminal, the two cable wires 51b and 51d for connection to the N(O)-phase terminal, and the cable wire 51c for connection to the W1-phase terminal as well as the earth wire 55.

The connection cable 5 includes four cable wires 51 each having the cable terminals 53 and 54 at both ends. Among these, the cable terminals 53 of two of the cable wires 51 are integrated together so that they are connected to one of the three output terminals of the generator.

In the present embodiment, one ends of the two cable wires 51b and 51d for connection to N(O)-phase terminals, which are connected to the connection terminals (N(O) phase) T12 and T14 of the generator distribution box 1, respectively constitute cable terminals 54b and 54d (FIG. 6). On the other hand, the other ends of the two cable wires 51b and 51d for connection to the N(O)-phase terminals, which are connected to the output terminal (N(O)-phase) T522 of the generator, constitutes a single cable terminal 53b (FIG. 17).

In the present embodiment, as shown in FIGS. 15 and 17, in the single-phase terminal section 506 for a single-phase three-wire 100 V (or 110 V) system provided in the output terminal board 504 of the generator 500, the cable terminal 53a of the cable wire 51a for connection to the U1-phase terminal of the connection cable 5 is connected to the output terminal (U1-phase) T521. The cable terminal 53b of the two cable wires 51b and 51d for connection to the N-phase terminal of the connection cable 5 is connected to the output terminal (N(O)-phase) T522. The cable terminal 53c of the cable wire 51c for connection to the W1-phase terminal of the connection cable 5 is connected to the output terminal (W1-phase) T523. The external ground terminal (G)56 of the earth wire 55 is connected to the external ground terminal GT524.

On the other hand, as shown in FIGS. 6 and 15, the connection terminal (U1-phase) T11 provided in the terminal section 47 on the rear surface 46 of the outlet panel 4 is connected to the cable terminal 54a of the cable wire 51a for connection to the U1-phase terminal of the connection cable 5. The cable terminal 54b of the cable wire 51b for connection to the N(O)-phase terminal of the connection cable 5 is connected to the connection terminal (N(O) phase) T12.

The cable terminal 54c of the cable wire 51c for connection to the W1-phase terminal of the connection cable 5 is connected to the connection terminal (W1-phase) T13. The cable terminal 54d of the cable wire 51d for connection to an N(O)-phase terminal of the connection cable 5 is connected to the connection terminal (N(O)-phase) T14. The external ground terminal (G)57 of the earth wire 55 is connected to the external ground terminal (G)T15.

The connection terminal (U1-phase) T21, which is connected to the connection terminal (U1-phase) T11, is connected to the terminal T42 of the sub-breaker switch 43b (FIG. 14) via the internal cable wire 151a (FIG. 15). The connection terminal (N(O)-phase) T22, which is connected to the connection terminal (N(O)-phase) T12, is connected to the terminal T41 of the sub-breaker switch 43b (FIG. 14) via the internal cable wire 151b (FIG. 15).

The connection terminal (U1-phase) T23, which is connected to the connection terminal (W1-phase) T13, is connected to the terminal T32 of the sub-breaker switch 43a (FIG. 14) via the internal cable wire 151c (FIG. 15). The connection terminal (N(O)-phase) T24, which is connected to the connection terminal (N(O)-phase) T14, is connected to the terminal T31 of the sub-breaker switch 43a (FIG. 14) via the internal cable wire 151d (FIG. 15). The external ground terminal (G)T25, which is connected to the external ground terminal (G)T15, is connected to external ground (earth) terminals (G)T71 and T72 (FIG. 14) via the internal earth wire 155 (FIG. 15).

The terminal T34 of the sub-breaker switch 43a (FIG. 14) is connected to the terminals T61 of the breaker switches 42b, which are respectively included in the first, third, and fifth outlet sets 421, 423, and 425 (FIG. 14), via three internal cable wires 251c (FIG. 15).

As shown in FIG. 14, the terminals T62 of the breaker switches 42b included in the first, third, and fifth outlet sets 421, 423, and 425 are connected to the terminals T52 provided on side surfaces of the housings of the two outlet sockets 42a provided in each of the first, third, and fifth outlet sets 421, 423, and 425, via internal cable wires 351c (FIG. 15).

As shown in FIG. 14, the terminal T33 of the sub-breaker switch 43a is connected to the terminals T54 provided on the side surfaces of the two outlet sockets 42a of each of the first, third, and fifth outlet sets 421, 423, and 425, via three internal cable wires 251d (FIG. 15).

Meanwhile, the terminal T44 of the sub-breaker switch 43b (FIG. 14) is connected to the terminals T61 of the breaker switches 42b, which are respectively included in the second, fourth, and sixth outlet sets 422, 424, and 426, via three internal cable wires 251a (FIG. 15).

As shown in FIG. 14, the terminals T62 of the breaker switches 42b included in the second, fourth, and sixth outlet sets 422, 424, and 426 are connected to the terminals T52 provided on side surfaces of the housings of the two outlet sockets 42a provided in each of the second, fourth, and sixth outlet sets 422, 424, and 426, via internal cable wires 351a (FIG. 15).

As shown in FIG. 14, the terminal T43 of the sub-breaker switch 43b is connected to the terminals T54 provided on the side surfaces of the two outlet sockets 42a of each of the second, fourth, and sixth outlet sets 422, 424, and 426, via three internal cable wires 251b (FIG. 15).

In the housing of the two outlet sockets 42a included in each of the outlet sets 42 (FIG. 14), the terminals T51 and T52 are connected via an internal cable wire, and the terminals T53 and T54 are connected via an internal cable wire (FIG. 15).

The external ground (earth) terminals (G) T55 (FIG. 14) of the first, third, and fifth outlet sets 421, 423, and 425 are connected to the external ground (earth) terminal (G)T71 via respective internal earth wires (FIG. 15). The external ground (earth) terminals (G)T55 (FIG. 14) of the second, fourth, and sixth outlet sets 422, 424, and 426 are connected to the external ground (earth) terminal (G)T72 via respective internal earth wires (FIG. 15).

In the present embodiment, such wiring connections are provided between the generator 500 and the generator distribution box 1, and also within the outlet panel 4 of the generator distribution box 1. Accordingly, the generator distribution box 1 is capable of supplying both a single-phase 100V (or 110V) power between the U1 and N(O) phases and a single-phase 100V (or 110V) power between the W1 and N(O) phases. As a result, it is possible to increase the number of connection ports for power distribution destinations that require single-phase 100 V (or 110 V) power. That is, the generator distribution box 1 according to the present embodiment can add a number of (twelve single-phase 100 V (or 110 V) outlet sockets 42a as an example shown in FIG. 1), by means of such wiring configuration, thereby enabling supply of single-phase 100 V (or 110 V) power to a number of power supply destinations.

As described above, the box body 2 of the generator distribution box 1 according to the present embodiment can be hooked on the generator 500 by means of the hooking member 6, for example, as shown in FIG. 16. In this hooked state, the operator of the generator distribution box 1 connects the connection cable 5, which is connected to the connection terminals T11 to T14 and the external ground terminal T15 of the box body 2, to the output terminals T521 to T523 and the external ground terminal (G)T524 of the generator 500. In one example of this connection operation, the operator of the generator distribution box 1 pulls out the connection cable 5, which is connected to the connection terminals T11 to T14 and the external ground terminal T15, through the slits 45b of the lead-out hole 45 (FIG. 7) to the outside of the box body 2, and then connects the pulled-out connection cable 5 to the output terminals T521 to T523 and the external ground terminal (G)T524.

In another example of this connection operation, the operator may connect one end of the connection cable 5 to the connection terminals T11 to T14 and the external ground terminal T15 by introducing it from outside the box body 2 into the box body 2 through the slits 45b of the lead-out hole 45 (FIG. 7), and connect the other end of the connection cable 5 to the output terminals T521 to T523 and the external ground terminal (G)T524.

As shown in FIG. 16, when the generator distribution box 1 according to the present embodiment is used with the generator 500, the box body 2 is hooked onto the generator 500 by engaging the two hooks 61 of the hooking member 6 with the bar member 501 of the generator 500. In this state, a user of the outlet socket 42a provided in the box body 2 introduces, for example, a power cord (not shown) of a power supply destination into the first accommodating section 23 of the box body 2 through the slits 44b of the lead-in hole 44, and then inserts the plug of the power cord into the outlet socket 42a. In this way, by introducing the power cord into the first accommodating section 23 of the box body 2 through the lead-in hole 44, it is possible to close the open side 21 with the lid 3 after the power cord of the power supply destination is inserted into the outlet socket 42a. As a result, it is possible to prevent foreign matter such as dust and debris, and water such as rainwater from entering the inside of the generator distribution box 1.

However, the user of the outlet socket 42a may insert the power cord of the power supply destination into the outlet socket 42a without interposing the lead-in hole 44 of the box body 2 hooked onto the generator 500 by means of the hooking member 6. To prevent foreign matter such as dust or debris and water (such as rainwater) from entering the inside of the generator distribution box 1, it is preferable to insert the power cord into the outlet socket 42a through the lead-in hole 44 and close the open side 21 with the lid 3.

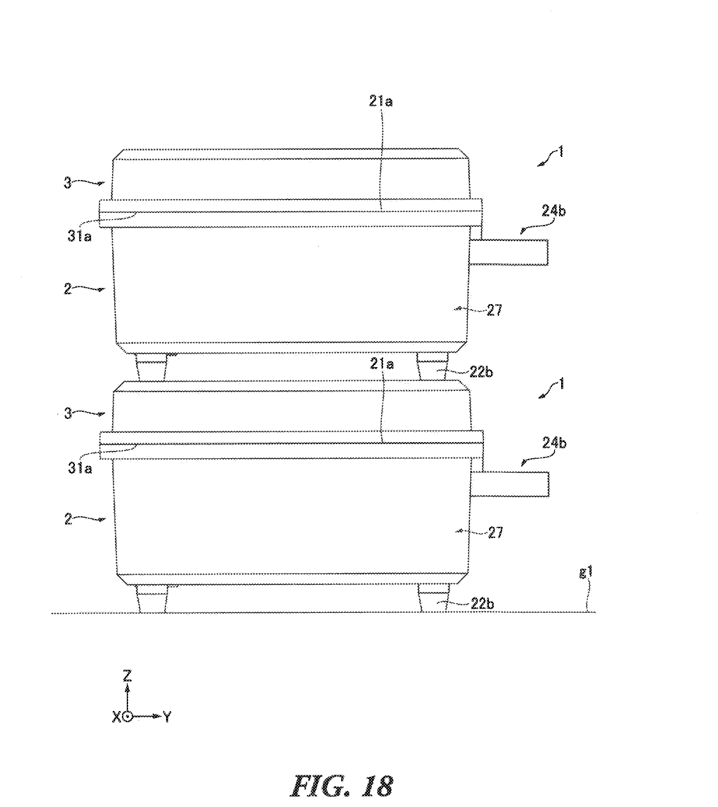

Moreover, the generator distribution box 1 according to the present embodiment includes the four protruding legs 22b provided on the bottom outer surface 22a. Therefore, as shown in FIG. 18, the generator distribution boxes 1 can be stacked such that one box body 2 is placed on the lid 3 of another while the open side 21 is closed by the lid 3, for storage. That is, one generator distribution box 1 is placed sideways so that its vertical direction (the Y-direction and the direction opposite to the Y-direction) lies along the horizontal plane g1, with its four protruding legs 22b resting on the horizontal plane g1. Then, another generator distribution box 1, which is also placed sideways, is stacked on the one generator distribution box 1 so that its protruding legs 22b come into contact with the lid 3 of the one generator distribution box 1.

In this manner, a plurality of generator distribution boxes 1 placed sideways can be stacked vertically with respect to the horizontal plane g1 for storage. By stacking the plurality of generator distribution boxes 1 on one another in such a sideways orientation, the plurality of generator distribution boxes 1 can be stored and kept in a compact and stable manner.

In this case, as shown in FIG. 18, the plurality of generator distribution boxes 1 can be stacked in an unused state in which the outlet panel 4, the connection cable 5, the hooking member 6, and the elevating member 7 are accommodated in the first and second accommodating sections 23 and 33 of each of the generator distribution boxes 1. Each of the protruding legs 22b may be formed, for example, such that at least its tip is made of an insulating material such as rubber. As a result, the protruding legs 22b provide an anti-slip effect. In addition, in the horizontally oriented arrangement of the plurality of generator distribution boxes 1 as shown in FIG. 18, it is possible to prevent scratches and other damage to the outer surface of the lid 3 of one generator distribution box 1, caused by the protruding legs 22b of another generator distribution box 1 stacked on top of the one generator distribution box 1.

According to the generator distribution box 1 of the present embodiment, the box body 2 can be easily mounted on a part of the generator or a peripheral facility of the generator by means of the hooking member 6. By mounting the box body 2 on a part of the generator or a peripheral facility of the generator using the hooking member 6, the generator distribution box 1 can be installed without being placed on the ground around the generator. As described above, the generator distribution box 1 can be easily installed on a part of one generator or a peripheral facility of the generator. In addition, the generator distribution box 1 can be easily carried by holding the portable handle 24b when it is moved from one generator to another, thereby providing excellent portability and high convenience. Moreover, the generator distribution boxes 1 can be efficiently stored by stacking a plurality of generator distribution boxes 1 one upon another.

### Modification

The above-described generator distribution box 1 is provided while the connection cable 5, the hooking member 6 including the hooks 61 and the mounting portion 62, and the elevating member 7 are accommodated in the second accommodating section 33 of the lid 3.

On the other hand, in a modification of the generator distribution box 1, while the connection cable 5 is accommodated in the second accommodating section 33, the hooking member 6 (or the hooking member 6 attached to the elevating member 7) may be attached in advance on the bottom outer surface 22a. With this modification, the generator distribution box 1 can be installed without being placed on the ground around the generator, and easily installed on one generator as described above. Moreover, the generator distribution box 1 is designed to provide excellent portability and high convenience when being moved from one generator to another.

As described above, the generator distribution box according to the embodiment and the modification can be installed without being placed on the ground around the generator and easily installed on one generator. Moreover, the generator distribution box has excellent portability and high convenience when being moved from one generator to another.

As described above, the embodiments of the present invention have been described in detail with reference to the drawings. However, the specific configuration is not limited to the embodiments, and the design can be changed without departing from the scope of the present invention. In addition, the above-described embodiments can be combined by utilizing each other’s technology as long as there is no particular contradiction or problem in the purpose and configuration.

1. A generator distribution box configured to increase connection ports for power supply destinations, the generator distribution box comprising:
a box body including an open side;
a lid configured to open or close the open side; and an outlet panel accommodated in the box body and including a plurality of outlet sockets exposed through the open side, wherein:
connection terminals of the outlet panel are exposed through an opening formed in a bottom portion of the box body;
the lid accommodates a connection cable to connect the connection terminals to output terminals of a generator, and a hooking member adapted to be attachable to an outer surface of the box body so that the box body is hooked on a part of the generator or a peripheral facility of the generator by means of the hooking member; and
a portable handle is provided on at least one of the box body and the lid.

2. The generator distribution box according to claim 1, wherein a lead-out hole configured to lead out the connection cable connected to the connection terminals is formed in the box body.

3. The generator distribution box according to claim 1, wherein:
the connection cable includes four cable wires each having cable terminals at both ends; and
among the four cable wires, one ends of the cable terminals of two cable wires are integrated together so as to be connected to one of three output terminals of the generator.

4. The generator distribution box according to claim 1, wherein the lid accommodates an elevating member configured to elevate the hooking member and attach the hooking member to the outer surface of the box body.

5. The generator distribution box according to claim 1, wherein the consent panel includes outlet sets with breaker switches, and a sub-breaker switch is provided for a plurality of outlet sets.

6. The generator distribution box according to claim 5, wherein:
a plurality of outlet sets connected to one of sub-breaker switches are disposed in a first row of the outlet panel;
a plurality of outlet sets connected to the other of the sub-breaker switches are disposed in a second row of the outlet panel; and
the outlet sets in the first row are assigned odd numbers, and the outlet sets in the second row are assigned even numbers.

7. The generator distribution box according to claim 1, wherein the box body is provided with protruding legs so as to stack another box body on the lid of the box body while the open side is closed with the lid.

8. A generator distribution box comprising:
a box body including an open side;
a lid mounted to the box body so as to allow the open side to be opened or closed; and
an outlet panel accommodated in the box body and including a plurality of outlet sockets exposed through the open side, wherein:
connection terminals of the outlet panel are exposed through an opening formed in a bottom portion of the box body;
the connection terminals can be connected to output terminals of a generator;
a hooking member is adapted to be attachable to an outer surface of the box body so that the box body is hooked on a part of the generator or a peripheral facility of the generator by means of the hooking member; and
a portable handle is provided on at least one of the box body and the lid.
